(19) United States
(12) Patent Application Publication
(10) Pub. No.: US 2019/0036212 A1
(43) Pub. Date: Jan. 31, 2019

(54) ANTENNA DEVICE AND ELECTRONIC DEVICE COMPRISING SAME

(71) Applicant: Samsung Electronics Co., Ltd., Gyeonggi-do (KR)

(72) Inventors: Jong-won Lee, Gyeonggi-do (KR); Soon Park, Gyeonggi-do (KR); Sung-chan An, Gyeonggi-do (KR); Hae-kwon Lee, Gyeonggi-do (KR); Dong-il Son, Gyeonggi-do (KR)

(73) Assignee: Samsung Electronics Co., Ltd.

(21) Appl. No.: 16/146,568

(22) Filed: Sep. 28, 2018

Related U.S. Application Data
(63) Continuation of application No. PCT/KR2017/003437, filed on Mar. 30, 2017.

(30) Foreign Application Priority Data
Apr. 1, 2016 (KR) 10-2016-0040205

(51) Int. Cl. H01Q 1/52; H04B 1/40; H04B 7/0404; H01Q 1/24

(52) U.S. Cl. CPC H01Q 1/521; H04B 1/40; H01Q 1/2291; H01Q 1/243; H04B 7/0404

(57) ABSTRACT

Provided are an antenna device and an electronic device including the same. The antenna device included in the electronic device according to an embodiment includes a first conductive pattern, a second conductive pattern spaced apart from the first conductive pattern, and an insulating layer between the first and second conductive patterns, wherein the first and second conductive patterns at least partially overlap each other when viewed from above.

### PRIORITY

This application is a continuation of international application no. PCT/KR2017/003437 filed on Mar. 30, 2017, which is based on and claims priority to Korean Application No. 10-2016-0040205 filed on Apr. 1, 2016, the entire content of each of which are incorporated herein by reference.

### BACKGROUND

### 1. Field

The present disclosure relates to an electronic device, for example, an electronic device including an antenna device.

### 2. Description of the Related Art

Owing to the development of electronic communication technology, electronic devices having various functions have emerged. Such electronic devices may include a convergence function for performing a combination of one or more functions.

Recently, since functional differences have reduced between each manufacturer, electronic devices are getting slimmer in order to meet the purchasing needs of consumers. Since the rigidity of electronic devices has increased, design aspects thereof have strengthened, and at the same time, electronic devices have become slimmer, it is difficult to secure a space for arranging at least one antenna device and to prevent deterioration of radiation performance.

In the case of an antenna having limited size and structure change according to the prior art, an antenna isolation characteristic may be degraded and radiation characteristics may be difficult to secure. However, according to an antenna structure according to various embodiments, a device having the antenna structure, and a method of manufacturing the antenna structure, isolation and radiation characteristics may be improved and other characteristics may also be improved.

### SUMMARY

The present disclosure has been made to address at least the problems and disadvantages described above, and to provide at least the advantages described below. According to an aspect of the present disclosure, an antenna device includes a first conductive pattern; a second conductive pattern spaced apart from the first conductive pattern; and an insulating layer between the first conductive pattern and the second conductive pattern, wherein the first conductive pattern and the second conductive pattern at least partially overlap each other when viewed from above.

According to an aspect of the present disclosure, an electronic device includes a housing including a first surface facing a first direction, a second surface facing a second direction that is a direction opposite to the first direction, and a side member surrounding a space between the first surface and the second surface; a first conductive pattern inside the housing; a second conductive pattern inside the housing, the second conductive pattern being spaced apart from the first conductive pattern and extending substantially parallel to the first conductive pattern, wherein at least a part of the second conductive pattern overlaps the first conductive pattern when viewed from above the first conductive pattern; an insulating material between the first conductive pattern and the second conductive pattern; and at least one wireless communication circuit electrically connected to the first conductive pattern at a first point and electrically connected to the second conductive pattern at a second point spaced apart from the first point.

According to an aspect of the present disclosure, an electronic device includes a plurality of antennas; a feeder; and a communication module coupled to the feeder, wherein two adjacent antennas selected from among the plurality of antennas include: a first conductive pattern; a second conductive pattern spaced apart from the first conductive pattern; and an insulating layer between the first conductive pattern and the second conductive pattern, wherein the first conductive pattern and the second conductive pattern at least partially overlap each other when viewed from above, and wherein the communication module is electrically connected to the first conductive pattern at a first point and electrically connected to the second conductive pattern at a second point spaced apart from the first point.

According to various embodiments, since two spaced antennas partly overlap each other, the antennas may exhibit an isolation characteristic equivalent to a direct connection of feeders of the two antennas and prevent antenna efficiency from deteriorating in a specific band (e.g. 5 GHz). Also, since the overlapping is non-contact, no element is required to prevent electric shock. Therefore, the configuration of a device may be simplified, and a wider mounting space may be ensured.

### BRIEF DESCRIPTION OF DRAWINGS

The above and other aspects, features and advantages of the present disclosure will be more apparent from the following detailed description taken in conjunction with the accompanying drawings, in which:

FIG. 1 illustrates a network environment including an electronic device, according to various embodiments;

FIG. 2 is a block diagram of an electronic device according to various embodiments;

FIG. 3 is an exploded perspective view of an electronic device including an antenna device, according to various embodiments;

FIG. 4 is an interior plan view of an electronic device including an antenna device, according to various embodiments;

FIG. 5 is a plan view showing an example of a part including an antenna structure with a vertical coupling, according to various embodiments;

FIG. 6 is a plan view showing a disposition of an antenna of an electronic device including a part of the electronic device;

FIG. 7 is a plan view of a part of an electronic device including an antenna, according to various embodiments;

FIG. 8 is a plan view of an example of an antenna disposed in an antenna device included in an electronic device, according to various embodiments;

FIG. 9 is a plan view of an example of an antenna disposed in an antenna device included in an electronic device, according to various embodiments; and

FIG. 10 is a cross-sectional view showing an arrangement of antennas mounted on an antenna device included in an electronic device, according to various embodiments.

### DETAILED DESCRIPTION

As the present disclosure allows for various changes and numerous embodiments, some exemplary embodiments will be described in detail with reference to the accompanying drawings. However, the embodiments do not limit the present disclosure to a specific implementation, but should be construed as including all modifications, equivalents, and replacements included in the spirit and scope of the present disclosure.

According to an aspect of the present disclosure, an antenna device includes a first conductive pattern; a second conductive pattern spaced apart from the first conductive pattern; and an insulating layer between the first conductive pattern and the second conductive pattern, wherein the first conductive pattern and the second conductive pattern at least partially overlap each other when viewed from above.

According to an aspect of the present disclosure, an electronic device includes a housing including a first surface facing a first direction, a second surface facing a second direction that is a direction opposite to the first direction, and a side member surrounding a space between the first surface and the second surface; a first conductive pattern inside the housing; a second conductive pattern inside the housing, the second conductive pattern being spaced apart from the first conductive pattern and extending substantially parallel to the first conductive pattern, wherein at least a part of the second conductive pattern overlaps the first conductive pattern when viewed from above the first conductive pattern; an insulating material between the first conductive pattern and the second conductive pattern; and at least one wireless communication circuit electrically connected to the first conductive pattern at a first point and electrically connected to the second conductive pattern at a second point spaced apart from the first point.

According to an aspect of the present disclosure, an electronic device includes a plurality of antennas; a feeder; and a communication module coupled to the feeder, wherein two adjacent antennas selected from among the plurality of antennas include: a first conductive pattern; a second conductive pattern spaced apart from the first conductive pattern; and an insulating layer between the first conductive pattern and the second conductive pattern, wherein the first conductive pattern and the second conductive pattern at least partially overlap each other when viewed from above, and wherein the communication module is electrically connected to the first conductive pattern at a first point and electrically connected to the second conductive pattern at a second point spaced apart from the first point.

Hereinafter, the present disclosure will be described in detail with reference to the accompanying drawings. The present disclosure may have various embodiments, and modifications and changes may be made therein without departing from the scope and spirit of the present disclosure. Therefore, it should be understood that there is no intent to limit the present disclosure to the particular forms, and the present disclosure should be construed to cover all modifications, equivalents, and/or alternatives falling within the spirit and scope of the present disclosure. In describing the drawings, the same or similar elements are designated by similar reference numerals.

As used herein, the expressions “have”, “may have”, “include”, and “may include” refer to the existence of a corresponding feature (e.g., numeral, function, operation, or constituent element such as component), and do not exclude one or more additional features.

In the present disclosure, the expressions “A or B”, “at least one of A or/and B”, and “one or more of A or/and B” may include all possible combinations of the items listed. For example, the expressions “A or B”, “at least one of A and B”, and “at least one of A or B” refer to all of (1) including at least one A, (2) including at least one B, and (3) including all of at least one A and at least one B.

The expressions “a first”, “a second”, “the first”, and “the second” used in embodiments of the present disclosure may modify various components regardless of the order and/or the importance but does not limit the corresponding components. For example, a first user device and a second user device indicate different user devices, although both of the devices are user devices. For example, a first element may be referred to as a second element, and similarly, a second element may be referred to as a first element without departing from the scope of the present disclosure.

When an element (e.g., a first element) is referred to as being (operatively or communicatively) “connected” or “coupled” to another element (e.g., a second element), this element may be directly connected or directly coupled to the other element or any other element (e.g., a third element) may be interposed between them. By contrast, when an element (e.g., a first element) is referred to as being “directly connected” or “directly coupled” to another element (e.g., a second element), there is no element (e.g., a third element) interposed between them.

The expression “configured to” as used herein may be used interchangeably with, for example, “suitable for”, “having the capacity to”, “designed to”, “adapted to”, “made to”, or “capable of” according to the situation. The term “configured to” may not necessarily imply “specifically designed to” with respect to hardware. Alternatively, in some situations, the expression “device configured to” may mean that the device, together with other devices or components, “is able to”. For example, the phrase “processor adapted (or configured) to perform A, B, and C” may refer to a dedicated processor (e.g., an embedded processor) used only to perform the corresponding operations or a generic-purpose processor (e.g., a central processor (CPU) or an application processor (AP)) that may perform the corresponding operations by executing one or more software programs stored in a memory device.

The terms used herein are merely used for the purpose of describing particular embodiments and do not limit the scope of other embodiments of the present disclosure. As used herein, singular forms of terms may include plural forms as well, unless the context clearly indicates otherwise. Unless defined otherwise, all terms used herein, including technical and scientific terms, have the same definitions as those commonly understood by a person of ordinary skill in the art to which the present disclosure pertains. Such terms as those defined in a generally used dictionary may be interpreted to have the same definitions as the contextual definitions in the relevant field of art, and are not to be interpreted to have ideal or excessively formal definitions, unless clearly defined in the present disclosure. In some cases, even terms defined in the present disclosure should not be interpreted in a manner that excludes embodiments of the present disclosure.

An electronic device according to various embodiments may include at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, a wearable device, and a virtual reality (VR) device. According to various embodiments, the wearable device may include at least one of an accessory type device (e.g., a watch, a ring, a bracelet, an anklet, a necklace, a spectacle, a contact lens or a head-mounted-device (HMD)), a texture or clothes integral type device (e.g., electronic apparel), a body attachment type device (e.g., a skin pad or tattoos), and a bio-implantable type device (e.g., an implantable circuit).

In some embodiments, the electronic device may be a home appliance. The home appliance may include at least one of, for example, a television, a digital video disk player, audio, a refrigerator, an air conditioner, a vacuum cleaner, an oven, a microwave, washing machine, an air cleaner, a set-top box, a home automation control panel, a security control panel, a TV box (e.g., Samsung HomeSync™, Apple TV™ or Google TV™), a game console (e.g., Xbox™ or PlayStation™), an electronic dictionary, an electronic key, a camcorder, and an electronic photo frame.

In another embodiment, the electronic device may include at least one of a variety of medical devices (e.g., various portable medical measurement devices such as a blood glucose meter, a heart rate meter, a blood pressure meter, or a body temperature meter), magnetic resonance angiography (MRA), magnetic resonance imaging (MRI), computed tomography (CT), a photographing device, a ultrasonic device, etc.), a navigation system, a global navigation satellite system (GNSS), an event data recorder (EDR), a flight data recorder (FDR), a vehicle infotainment system, ship electronic equipment (e.g., a ship navigation system, a gyro compass, etc.), avionics, a security device, a vehicle head unit, an industrial or home robot, automatic teller's machine (ATM) of financial institutions, point of sales (POS) of shops, and an Internet of things device (e.g., a light bulb, various sensors, an electricity or gas meter, a sprinkler device, a fire alarm, a thermostat, a street light, a toaster, exercise equipment, a hot water tank, a heater, boiler, etc.)

According to some embodiments, the electronic device may include at least one of furniture or a part of a building/structure, an electronic board, an electronic signature receiving device, a projector, and various measuring instruments (e.g. water, electricity, gas, or radio wave measuring instrument, etc.) In various embodiments, the electronic device may be one of the various devices described above or a combination thereof. The electronic device according to some embodiments may be a flexible electronic device. Further, the electronic device according to an embodiment is not limited to the above-described devices, and may include a new electronic device according to technological advancement.

Hereinafter, an antenna device and an electronic device including the same according to various embodiments will be described with reference to the accompanying drawings. In the present disclosure, the term “user” may indicate a person using a device or a device (e.g., an artificial intelligence electronic device) using the device.

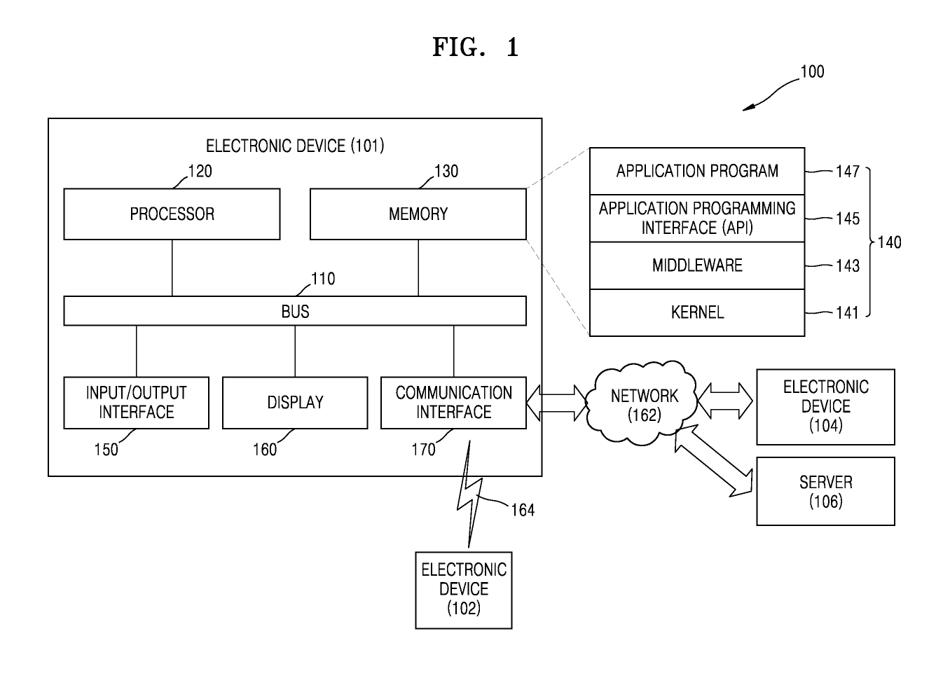

FIG. 1 illustrates a network environment 100 including an electronic device 101 according to various embodiments.

Referring to FIG. 1, according to various embodiments, the electronic device 101 operates in the network environment 100. The electronic device 101 may include a bus 110, a processor 120, a memory 130, an input/output interface 150, a display 160, and a communication interface 170. In some embodiments, the electronic device 101 may not include at least one of these components or may additionally include other components.

The bus 110 may include, for example, circuitry for connecting the components 110-170 to one another and for communicating communication (e.g., control messages and/or data) between the components 110 to 170.

The processor 120 may include one or more of a central processing unit (CPU), an application processor (AP), or a communication processor (CP). The processor 120 may perform computations or data processing related to, for example, control and/or communication of at least one other component of the electronic device 101.

The memory 130 may include volatile and/or non-volatile memory. The memory 130 may store, for example, command or data related to at least one other component of the electronic device 101. According to an embodiment, the memory 130 may store software and/or programs 140. The program 140 may include, for example, a kernel 141, middleware 143, an application programming interface (API) 145, and/or an application program (or an application) 147. At least some of the kernel 141, the middleware 143, or the API 145 may be referred to as an operating system (OS).

The kernel 141 may control or manage, for example, system resources (e.g., the bus 110, the processor 120, or the memory 130) used to perform an operation or a function implemented in other programs (e.g., the middleware 143, the API 145, or the application program 147). The kernel 141 may also provide an interface capable of or controlling or managing the system resources by accessing individual components of the electronic device 101 in the middleware 143, the API 145, or the application program 147.

The middleware 143 may serve, for example, as a router such that the API 145 or the application program 147 may communicate with the kernel 141 to exchange data.

Also, the middleware 143 may process one or more task requests received from the application program 147 according to priority. For example, the middleware 143 may assign priority capable for using the system resources (e.g., the bus 110, the processor 120, or the memory 130, etc.) of the electronic device 101 to at least one of the application programs 147. For example, the middleware 143 may perform scheduling or load balancing on the one or more task requests by processing the one or more task requests according to the priority assigned to the at least one of the application programs 147.

The API 145 is, for example, an interface for the application program 147 to control a function provided by the kernel 141 or the middleware 143. For example, the API 145 may include at least one interface or a function (e.g., instructions) for window control, image processing, character control, and the like.

The input/output interface 150 may serve as an interface by which, for example, command or data input from a user or another external device may be transmitted to another component(s) of the electronic device 101. The input/output interface 150 may output the command or data received from other component(s) of the electronic device 101 to the user or the other external device.

The display 160 may include, for example, a liquid crystal display (LCD), a light-emitting diode (LED) display, an organic light-emitting diode (OLED), a microelectromechanical systems (MEMS) display, or an electronic paper display. The display 160 may display, for example, various types of content (e.g., texts, images, videos, icons, or symbols, etc.) to the user. The display 160 may include a touch screen and may receive, for example, touch, gesture, proximity, or hovering input using an electronic pen or a part of a user's body.

The communication interface 170 may establish, for example, communication between the electronic device 101 and an external device (e.g., a first external electronic device 102, a second external electronic device 104, or a server 106). For example, the communication interface 170 may be connected to a network 162 through wireless or wired communication to communicate with the external device (e.g., the second external electronic device 104 or the server 106).

Wireless communication may use at last one of, for example, long-term evolution (LTE), LTE Advance (LTE-A), code division multiple access (CDMA), wideband CDMA (WCDMA), universal mobile telecommunications system (UMTS), Wireless Broadband (WiBro), and Global System for Mobile Communications (GSM) as a cellular communication protocol. Wireless communication may also include, for example, near field communication 164. The near field communication 164 may include at least one of, for example, wireless fidelity (WiFi), Bluetooth, near field communication (NFC), and a global navigation satellite system (GNSS). The GNSS may include at least one of, for example, a Global Positioning System (GPS), a Global Navigation Satellite System (Glonass), a Beidou Navigation Satellite System (Beidou), and a Galileo, and the European global satellite-based navigation system, according to a use area or a bandwidth. Hereinafter, in the present disclosure, the GPS may be interchangeably used with the GNSS. Wired communication may include at least one of, for example, a universal serial bus (USB), a high definition multimedia interface (HDMI), a recommended standard 232 (RS-232), and plain old telephone service (POTS). The network 162 may include at least one of a telecommunications network, for example, a computer network (e.g., LAN or WAN), the Internet, or a telephone network.

Each of the first and second external electronic devices 102 and 104 may be the same as or different from the electronic device 101. According to an embodiment, the server 106 may include one or more groups of servers. According to various embodiments, all or a part of operations performed by the electronic device 101 may be performed by another electronic device or a plurality of electronic devices (e.g., the electronic device 102 and 104, or the server 106). According to an embodiment, when the electronic device 101 performs a function or service automatically or according to a request, the electronic device 101 may request another device (e.g., the electronic device 102 and 104, or the server 106) to perform at least some functions related to the function or service instead of performing the function or service or additionally. The other device (e.g., the electronic device 102 and 104, or the server 106) may perform requested or additional functions and transmit results thereof to the electronic device 101. The electronic device 101 may process the received results as they are or additionally and provide the requested functions or services. To this end, for example, cloud computing, distributed computing, or client-server computing techniques may be used.

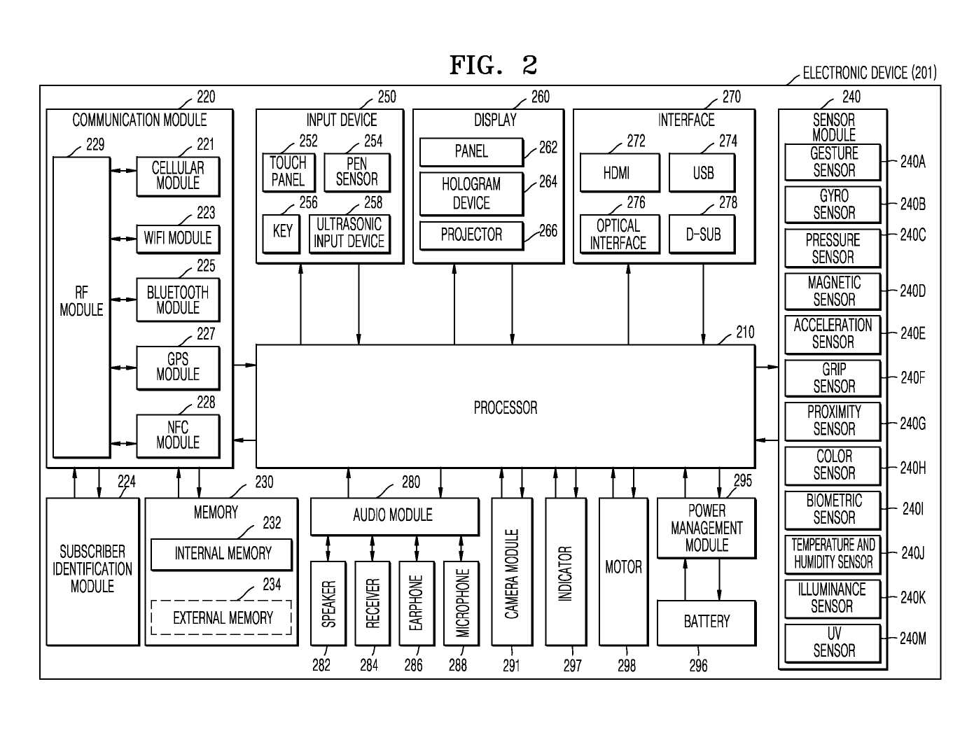

FIG. 2 is a block diagram of an electronic device 201 according to various embodiments.

The electronic device 201 may, for example, all or some of the electronic device 101 shown in FIG. 1. The electronic device 201 may include one or more processors (e.g., AP) 210, a communication module 220, a subscriber identification module 224, a memory 230, a sensor module 240, an input unit 250, a display 260, an interface 270, an audio module 280, a camera module 291, a power management module 295, a battery 296, an indicator 297, and a motor 298.

The processor 210 may, for example, operate an operating system or an application program to control a number of hardware or software components coupled to the processor 210 and perform various data processing and operations. The processor 210 may be implemented as, for example, a system on chip (SoC). According to an embodiment, the processor 210 may further include a graphics processing unit (GPU) and/or an image signal processor. The processor 210 may include at least some (e.g. a cellular module 221) among the components shown in FIG. 2. The processor 210 may load and process command or data received from at least one of other components (e.g., non-volatile memory) into volatile memory and store resulting data in the non-volatile memory.

The communication module 220 may have the same or similar configuration as that of the communication interface 170 of FIG. 1. The communication module 220 may include, for example, the cellular module 221, a WiFi module 223, a Bluetooth module 225, a GNSS module 227 (e.g. a GPS module, a Glonass module, a Beidou module, or a Galileo module), an NFC module 228 and an RF module 229.

The cellular module 221 may provide, for example, voice calls, video calls, text services, or Internet services over a communication network. According to an embodiment, the cellular module 221 may utilize the subscriber identification module (e.g., a subscriber identification module (SIM) card) 224 to perform identification and authentication with respect to the electronic device 201 within a communication network. According to an embodiment, the cellular module 221 may perform at least some of functions that the processor 210 may provide. According to an embodiment, the cellular module 221 may include a communications processor (CP).

Each of the WiFi module 223, the Bluetooth module 225, the GNSS module 227, and the NFC module 228 may include, for example, a processor for processing data transmitted and received through a corresponding module. According to some embodiments, at least some (e.g., two or more) of the cellular module 221, the WiFi module 223, the Bluetooth module 225, the GNSS module 227, and the NFC module 228 may be included in an integrated chip (IC) or an IC package. The RF module 229 may, for example, send and receive communication signals (e.g., RF signals).

The RF module 229 may include, for example, a transceiver, a power amplifier module (PAM), a frequency filter, a low noise amplifier (LNA), or an antenna. According to another embodiment, at least one of the cellular module 221, the WiFi module 223, the Bluetooth module 225, the GNSS module 227, and the NFC module 228 may transmit/receive an RF signal through a separate RF module.

The subscriber identification module 224 may include, for example, a card and/or an embedded SIM including a subscriber identification module and may include unique identification information (e.g., an integrated circuit card identifier (ICCID)) or subscriber information (e.g., international mobile subscriber identity (IMSI)).

The memory 230 (e.g., the memory 130) may include, for example, internal memory 232 or external memory 234. The internal memory 232 may include at least one of, for example, volatile memory (e.g., dynamic RAM (random access memory) (DRAM), static RAM (SRAM), or synchronous dynamic RAM (SDRAM)), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash, NOR flash, or the like), hard drive, or solid state drive (SSD).

The external memory 234 may include flash drive, for example, compact flash (CF), secure digital (SD), micro secure digital (Micro-SD), mini secure digital (Mini-SD), extreme digital (xD), multi-media card (MMC) or memory stick. The external memory 234 may be functionally and/or physically connected to the electronic device 201 through various interfaces.

The sensor module 240 may, for example, measure a physical quantity or sense an operating state of the electronic device 201 to convert measured or sensed information into an electrical signal. The sensor module 240 may include at least one of, for example, a gesture sensor 240A, a gyro sensor 240B, a barometer 240C, a magnetic sensor 240D, an acceleration sensor 240E, a grip sensor 240F, a proximity sensor 240G, a color sensor 240H (e.g., a red, green, blue (RGB) sensor), a medical sensor 240I, a temperature-humidity sensor 240J, an illuminance sensor 240K, and a ultra violet (UV) sensor 240M. Additionally or alternatively, the sensor module 240 may include, for example, an E-nose sensor, an electromyography (EMG) sensor, an electroencephalogram (EEG) sensor, an electrocardiogram (ECG sensor, an infrared (IR) sensor, an iris scan sensor, and/or a finger scan sensor. The sensor module 240 may further include a control circuit for controlling at least one or more sensors belonging to the sensor module 240. In some embodiments, the electronic device 201 may further include a processor configured to control the sensor module 240, either as part of the processor 210 or separately, to control the sensor module 240 while the processor 210 is in a sleep state.

The input unit 250 may include, for example, a touch panel 252, a (digital) pen sensor 254, a key 256, or an ultrasonic input unit 258. The touch panel 252 may use at least one of, for example, an electrostatic type, a pressure sensitive type, an infrared type, and an ultrasonic type. Furthermore, the touch panel 252 may further include a control circuit. The touch panel 252 may further include a tactile layer to provide a tactile response to the user.

The (digital) pen sensor 254 may, for example, be part of the touch panel 252 or may include a separate recognition sheet. The key 256 may include, for example, a physical button, an optical key, or a keypad. The ultrasonic input unit 258 may sense ultrasonic waves generated from an input tool through the microphone (e.g., 288) and confirm data corresponding to the sensed ultrasonic waves.

The display 260 (e.g., the display 160) may include a panel 262, a hologram unit 264, or a projector 266. The panel 262 may include the same or similar configuration as that of the display 160 of FIG. 1. The panel 262 may be implemented to be, for example, flexible, transparent, or wearable. The panel 262 and the touch panel 252 may be configured as one module. The hologram unit 264 may display a stereoscopic image in the air using the interference of light. The projector 266 may display an image by projecting light onto a screen. The screen may, for example, be located inside or outside of the electronic device 201. According to an embodiment, the display 260 may further include a control circuit for controlling the panel 262, the hologram unit 264, or the projector 266.

The interface 270 may include, for example, a high-definition multimedia interface (HDMI) 272, a universal serial bus (USB) 274, an optical interface 276, or a D-subminiature (D-sub) 278. The interface 270 may be included, for example, in the communication interface 170 shown in FIG. 1. Additionally or alternatively, the interface 270 may include, for example, a mobile high-definition link (MHL) interface, an SD card/multi-media card (MMC) interface, or an infrared data association (IrDA) standard interface.

The audio module 280 may convert, for example, sound and electrical signals in both directions. At least some components of the audio module 280 may be included, for example, in the input/output interface 150 shown in FIG. 1. The audio module 280 may process sound information input or output through, for example, a speaker 282, a receiver 284, an earphone 286, a microphone 288, or the like.

The camera module 291 is a unit capable of, for example, capturing still images and moving images, and according to an embodiment, may include one or more image sensors (e.g., a front sensor or a rear sensor), a lens, an image signal processor (ISP), or flash (e.g., an LED or xenon lamp, etc.).

The power management module 295 may manage, for example, power of the electronic device 201. According to an embodiment, the power management module 295 may include a power management integrated circuit (PMIC), a charger integrated circuit (IC), or a battery or a fuel gauge. The PMIC may have a wired and/or wireless charging method. The wireless charging method may include, for example, a magnetic resonance method, a magnetic induction method, or an electromagnetic wave method, and may further include an additional circuit for wireless charging, for example, a coil loop, a resonant circuit, or a rectifier. The battery gauge may measure, for example, a remaining amount of the battery 296, voltage, current, or temperature during charging. The battery 296 may include, for example, a rechargeable battery and/or a solar battery.

The indicator 297 may indicate a specific state of the electronic device 201 or a part thereof (e.g., the processor 210), such as a booting state, a message state, or a charging state. The motor 298 may convert an electrical signal to mechanical vibration, and may generate vibration, haptic effects, and the like. Although not shown, the electronic device 201 may include a processor (e.g. a GPU) for supporting mobile TV. The processor for supporting mobile TV may process media data conforming to standards such as digital multimedia broadcasting (DMB), digital video broadcasting (DVB), or media flow (mediaFlo™).

Each of the components described herein may include one or more components, and a name thereof may be changed according to a type of an electronic device. In various embodiments, the electronic device may include at least one of the components described herein, have some components omitted, and further include additional components. Also, the electronic device according to various embodiments have some of the components combined into one entity and performing functions of the components before combined in the same manner.

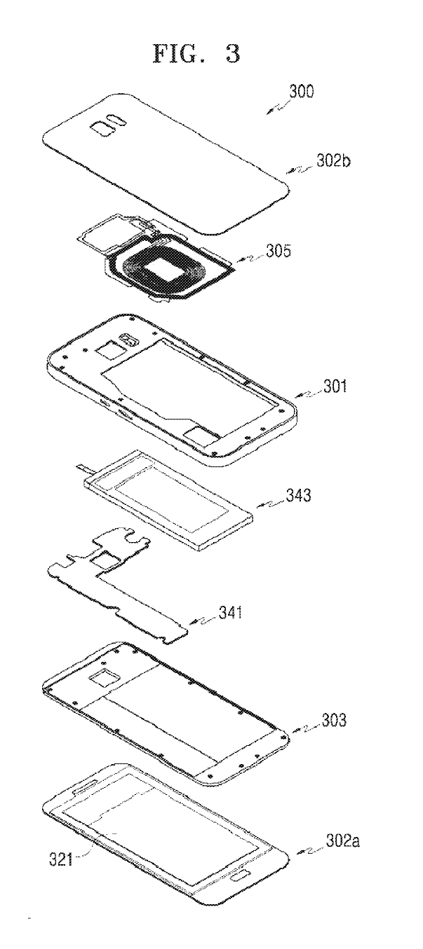

FIG. 3 is an exploded perspective view of an electronic device 300 including an antenna device according to various embodiments.

Referring to FIG. 3, the electronic device 300 may include a housing 301, at least one plate 302a, 302b, a conductive pattern unit 305, and a control circuit coupled to the conductive pattern unit 305.

The plate 302a may have a surface toward in a given direction, e.g., a first direction. The plate 302b may have a surface toward in a given direction, e.g., a second direction opposite to the first direction. The housing 301 may include a side member surrounding space between the two surfaces.

According to various embodiments, the housing 301 is for accommodating various electronic components and the like. At least a part of the housing 301 may include a conductive material. For example, the housing 301 may include sidewalls forming an outer surface of the electronic device 300. An exposed part of the electronic device 300 may include a conductive metal material. A circuit board 341 and/or a battery 343 may be accommodated in the housing 301. For example, a processor (e.g. the processor 201 of FIG. 2), a communication module (e.g. the communication module 220 of FIG. 2), various interfaces (e.g., the interface 270 of FIG. 2), and a power management module (e.g., the power management module 295 of FIG. 2), and the like may be mounted on the circuit board 341 in the form of integrated circuit chips. The control circuit may also be configured as an integrated circuit chip and mounted on the circuit board 341. For example, the control circuit may be part of the processor or the communication module described above. The antenna device may also be mounted on the housing 301. The antenna device may include at least two antennas forming a coupling structure. The at least two antennas may partly overlap each other. The coupling structure may be formed in at least the overlapping part.

According to various embodiments, the plates 302a, 302b may include a material that is at least partially permeable to radio waves or magnetic fields, and may include a front cover 302a mounted on the front of the housing 301 and a rear cover 302b mounted on the rear of the housing 301. The front cover 302a may include, for example, a display device 321. For example, the front cover 302a may include a window member including a tempered glass material and the display device 321 mounted on the inner surface of the window member. A touch panel may be mounted between the window member and the display device 321. For example, the front cover 302a may be utilized as an output device for outputting a screen and an input device equipped with a touch screen function. The rear cover 302b may be mounted to face the front cover 302a in an opposite direction and may include a material capable of transmitting radio waves or a magnetic field, for example, tempered glass or synthetic resin. The plates, e.g., the front cover 302a and the rear cover 302b, may be mounted on the housing 301 to form the appearance of the electronic device 300 together with the housing 301.

According to various embodiments, a support member 303 may be mounted in the housing 301. The support member 303 may include a metallic material and may be disposed in space formed by the housing 301 and the front cover 302a. For example, the support member 303 may be disposed between the display device 321 and the circuit board 341. The support member 303 may prevent the integrated circuit chips mounted on the circuit board 341 from contacting the display device 321 and may prevent electromagnetic interference between the integrated circuit chips by providing an electromagnetic shielding function. The support member 303 may compensate the rigidity of the electronic device 300. For example, the housing 301 may be formed with a plurality of openings or recessed portions depending on the arrangement of electronic components inside the electronic device 300, which may degrade the rigidity of the housing 301 or the electronic device 300. The support member 303 may be mounted and engaged in the housing 301, and thus the rigidity of the housing 301 and the electronic device 300 may be improved.

Although not shown in detail in the drawing, according to various embodiments, various structures may be formed on surfaces of the housing 301 and the support member 303 according to the arrangement of the electronic components disposed inside the electronic device 300 or the coupling structure between the housing 301 and the support member 303. For example, space for accommodating the integrated circuit chips mounted on the circuit board 341 may be formed in each of the housing 301 and/or the support member 303. The space for accommodating the integrated circuit chips may be formed in a recessed shape or a rib surrounding the integrated circuit chips or the like. According to various embodiments, fastening bosses and fastening holes corresponding to each other may be formed in the housing 301 and the support member 303. For example, a fastening member such as a screw is fastened to a fastening member or a fastening hole, and thus the housing 301 and the support member 303 may be engaged to face each other or may be engaged with the support member 303 being accommodated in the housing 301.

According to various embodiments, the conductive pattern unit 305 may be mounted on the housing 301 on a side opposite the circuit board 341. For example, the conductive pattern unit 305 may be located in space formed by the rear cover 302b and the housing 301. The conductive pattern unit 305 may include at least one conductive pattern, for example, a planar coil, through which radio waves may be transmitted or received or a magnetic field may be generated. According to various embodiments, radio waves transmitted or received through the conductive pattern unit 305 or the magnetic field generated by the conductive pattern unit 305 may transmit through the plate, for example, the rear cover 302b. For example, the rear cover 302b may include a tempered glass material or a synthetic resin material. In the case where the rear cover 302b includes a transparent material such as tempered glass, a coating layer may be formed on the inner or outer surface of the rear cover 302b to protect the inner structure of the rear cover 302b and an electronic component (e.g. the conductive pattern unit 305). The conductive pattern unit 305 may include a Magnetic Secure Transmission (MST) member, an NFC member, and/or a wireless charging coil, etc. The conductive pattern unit 305 may have various shapes, and FIG. 3 shows one example thereof.

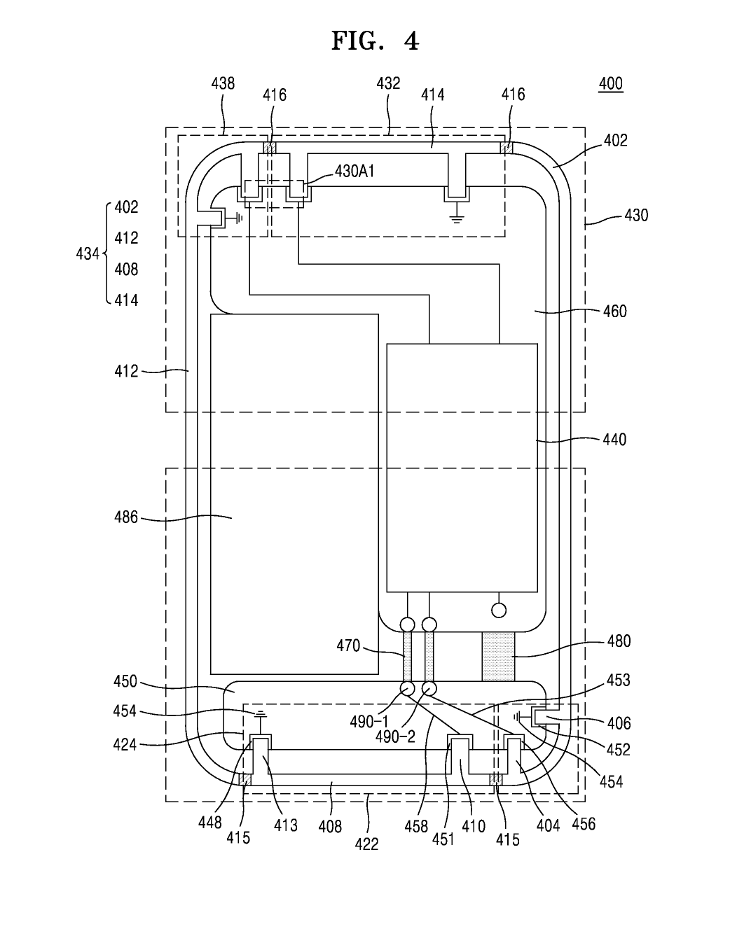

FIG. 4 is an interior plan view of an electronic device 400 including an antenna device according to various embodiments. FIG. 4 is a plan view viewed from a front cover side of the electronic device 400 of FIG. 4.

Referring to FIG. 4, the electronic device 400 may include a metal bezel 434. The electronic device 400 may include a main printed circuit board (PCB) 460, a sub PCB 450, and a battery 486. The main PCB 460, the sub PCB 450 and the battery 486 may be surrounded by the metal bezel 434. The main PCB 460 and the sub PCB 450 may be connected by a wiring 470. The wiring 470 may include, for example, a coaxial line and/or a flexible PCB. The main PCB 460 may be equipped with a circuit module 440 that supports an operation of the electronic device 400. The circuit module 440 may include at least a communication processor. The communication processor may include a plurality of communication modules.

The metal bezel 434 according to various embodiments of the present disclosure may include a pair of segmentation units 415 in its lower portion. The pair of segmentation units 415 may be arranged at certain intervals. The metal bezel 434 may have a pair of segmentation units 416 at its upper portion and may be provided at certain intervals. The segmentation units 415 and 416 may be formed at various positions. For example, some or all of the segmentation units 415 and 416 may be located on the left and right portions of the metal bezel 434. Other segmentation units may be located on the left and right portions of the metal bezel 434.

According to an embodiment, the segmentation units 415 and 416 formed in the metal bezel 434 may be formed of insulators.

At least a part of the metal bezel 434 may be used as a part of an antenna. For example, a middle portion of an upper portion of the metal bezel 434 may be used as a part of a third antenna 432, and a left portion of the upper portion thereof may be used as a part of a fourth antenna 438. At least a part of the third antenna 432 and at least a part of the fourth antenna 438 may overlap each other in a first region 442. At least parts of the third antenna 432 and the fourth antenna 438 in the first region 442 are vertically stacked and spaced apart from each other but may be electromagnetically coupled. This will be described later. The first region 442 may overlap at least a partial region of the main PCB 460.

According to various embodiments, the metal bezel 434 may be connected to a ground unit via a ground pad. The metal bezel 434 may have a ground piece protruding toward the main PCB 460 and the sub PCB 450. The ground piece may be connected to the ground unit via the ground pad. The ground pad and the ground unit may be provided on the main PCB 460 and the sub PCB 450.

According to various embodiments, the electronic device may include a housing including a first surface facing a first direction, a second surface facing a second direction that is a direction opposite to the first direction, and a side member surrounding space between the first surface and the second surface, a first conductive pattern disposed inside the housing, a second conductive pattern disposed inside the housing, the second conductive pattern being spaced apart from the first conductive pattern and substantially parallel to the first conductive pattern, wherein at least a part of the second conductive pattern overlaps the first conductive pattern when viewed from above the first conductive pattern, an insulating material between the first conductive pattern and the second conductive pattern, and at least one wireless communication circuit electrically connected to the first conductive pattern at a first point and electrically connected to the second conductive pattern at a second point spaced from the first point.

According to various embodiments, the first conductive pattern may extend parallel to the second surface.

According to various embodiments, the at least one wireless communication circuit may be configured to provide at least one Wi-Fi signal to each of the first and second points.

According to various embodiments, the at least one wireless communication circuit may be configured to provide a MIMO signal by using the first and second conductive patterns.

According to various embodiments, the electronic device may further include a first insulating layer attached to or embedded in the first conductive pattern and a second insulating layer attached to or embedded in the second conductive pattern, wherein the second insulating layer may be coupled to the first insulating layer.

According to various embodiments, the at least one wireless communication circuit may be configured to transmit and receive a signal related with at least one of RF, GPS, NFC, and Bluetooth by using the side member.

According to various embodiments, the at least one wireless communication circuit may be configured to transmit and/or receive a signal within a frequency range of about 600 MHz to about 5.9 GHz.

According to various embodiments, the electronic device may include a plurality of antennas, a feeder, and a communication module coupled to the feeder, wherein selected two adjacent antennas of the plurality of antennas include a first conductive pattern, a second conductive pattern spaced apart from the first conductive pattern; and an insulating layer between the first conductive pattern and the second conductive pattern.

The first conductive pattern and the second conductive pattern at least partially overlap with each other when viewed from above. The communication module may be electrically connected to the first conductive pattern at a first point and electrically connected to the second conductive pattern at a second point spaced apart from the first point.

According to various embodiments, the electronic device may further include a metal bezel surrounding the feeder and the communication module.

According to various embodiments, the plurality of antennas may include at least an RF antenna and a GPS antenna.

The selected two adjacent antennas may be Wi-Fi antennas.

The metal bezel may include a segmentation unit.

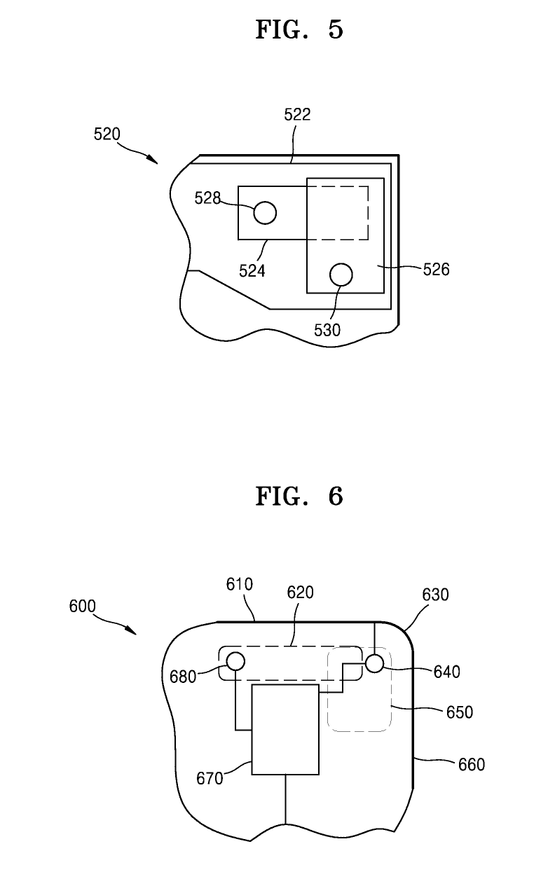

FIG. 5 is a plan view showing an example of an antenna device 520 included in an electronic device according to various embodiments. The antenna device 520 of FIG. 5 may be disposed, for example, in at least a partial region of the housing 301 of FIG. 3 or in a first region 430A1 of FIG. 4. Referring to FIG. 5, the antenna device 520 according to an embodiment may include an antenna structure with a coupling. The antenna device 520 may be disposed on a substrate 522. The substrate 522 may be a flexible printed circuit board (FPCB). The substrate 522 may be a PCB. Antennas may be disposed in some regions 524 and 526 of the substrate 522. A first type of antenna may be provided in the first region 524. A second type of antenna may be provided in the second region 526. The first and second types of antennas may be Multiple-Input Multiple-Output (MIMO) antennas, for example, WiFi antennas. For example, at least parts the first region 524 and the second region 526 may overlap as shown in the figure. At least parts of the first and second types of antennas may be present in the at least overlapping parts of the first and second regions 524 and 526. The at least overlapping parts may be coupled, for example, may be disposed to be vertically coupled. Shapes of the first and second regions 524 and 526 and shapes of the at least overlapping parts of the first and second regions 524 and 526 may vary depending on the electronic device (e.g., a communication device).

For example, in FIG. 5, the first region 524 and the second region 526 may be present to vertically intersect, but may be present in a straight line. For example, a first feeder 528 may be present in the first region 524 and a second feeder 530 may be present in the second region 526. Power may be supplied to the antenna formed in the first region 524 through the first feeder 528. Power may be supplied to the antenna formed in the second region 526 through the second feeder 530. Positions of the first and second feeders 528 and 530 may vary depending on the antenna design of the electronic device. The first and second feeders 528 and 530 may be present in a non-overlapping part of the first and second regions 524 and 526.

FIG. 6 is a plan view showing an example of an antenna device 600 included in an electronic device according to various embodiments. For the sake of convenience, a substrate is omitted in FIG. 6.

Referring to FIG. 6, the antenna device 600 included in the electronic device may include a first antenna region 620 and a second antenna region 650. For example, the first antenna region 620 may correspond to the first region 524 of FIG. 5. For example, the second antenna region 650 may correspond to the second region 526 of FIG. 5. Parts of the first antenna region 620 and the second antenna region 650 may overlap each other. The overlapping parts may be coupled, for example, may be disposed to be vertically coupled.

The antenna device 600 included in the electronic device according to various embodiments of the present disclosure may include at least one antenna. For example, at least one of the at least one antenna may include a first portion and a second portion. For example, the first portion and the second portion may be separate antennas.

The antenna device 600 included in the electronic device according to various embodiments of the present disclosure may be at least one Wi-Fi antenna. For example, the Wi-Fi antenna may include a first antenna and a second antenna, and may be formed in at least a part of a printed circuit board. For example, the first antenna may be formed in a first antenna region 620, and the second antenna may be formed in a second antenna region 650. For example, the at least one Wi-Fi antenna may be connected to at least one feeder. For example, the first antenna may include a first feeder, and the second antenna may include a second feeder. The first feeder and the second feeder may be connected to each other. For example, the first antenna and the second antenna may be coupled to each other.

The antenna device 600 included in the electronic device according to various embodiments of the present disclosure may include a first Wi-Fi antenna in the first antenna region 620. The second antenna region 650 may include a second Wi-Fi antenna. A first feeder 680 may be present at one point of the first antenna region 620. The second feeder 640 may be present at one point of the second antenna region 650. The first and second feeders 680 and 640 may be connected to a communication module 670. The communication module 670 may be included in the communication module 220 of FIG. 2. The communication module 670 may include at least one wireless communication circuit. The at least one wireless communication circuit may be configured to transmit and/or receive a signal within a frequency range of about 600 MHz to about 5.9 GHz. The communication module 670 may be spaced apart from the first and second antenna regions 620 and 650. The communication module 670 may be arranged to provide a Wi-Fi signal or a MIMO signal to the antennas provided in the first and second antenna regions 620 and 650 through the first and second feeders 680 and 640, respectively. The first and second antenna regions 620 and 650 are spaced apart from peripheral metal bezels 610 and 660. A segmentation unit may be present between the peripheral metal bezels 610 and 660. The upper bezel 610 of the rim may be parallel to the first antenna region 620. The right bezel 660 may be parallel to the second antenna region 650. The second feeder 640 in the second antenna region 650 may be connected to a part adjacent to the upper bezel 610 of the right bezel 660, i.e. a curved part 630 of the right bezel 660.

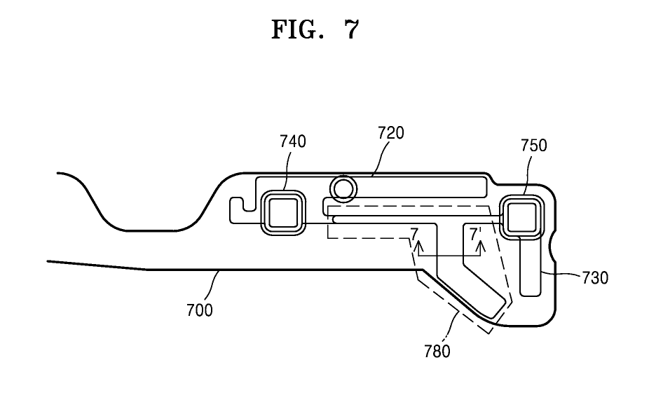

FIG. 7 is a plan view of a part of an electronic device including an antenna 760 according to various embodiments.

An example of the arrangement of the antenna 760 may be shown in FIG. 7.

The arrangement of the antenna 760 illustrated in FIG. 7 may be an example of an antenna that may be disposed in the first and second antenna regions 620 and 650 of FIG. 6.

Referring to FIG. 7, at least a part of the antenna 760 may be formed in at least a partial region of a substrate 700. For example, the antenna 760 formed in the at least a partial region of the substrate 700 may include a first portion and a second portion. The antenna 700 may include a first antenna 720 and a second antenna 730. For example, the first antenna 720 and the second antenna 730 may be disposed on the substrate 700. For example, the substrate 700 may be at least one of a PCB and an FPCB. The first antenna 720 and the second antenna 730 may partially overlap each other. The first region 780 may be an overlapped portion of the first and second antennas 720 and 730. A first feeder 740 may be connected to the first antenna 720. The second feeder 750 may be connected to the second antenna 730. Power may be supplied to the antennas 720 and 730 through the first and second feeders 740 and 750, respectively. A wireless signal, for example, a Wi-Fi signal or a MIMO signal may be provided to the first and/or second antennas 720 and/or 730 from a communication module (e.g. 670 of FIG. 6). A wireless signal received from outside may be delivered to the communication module through the first and/or second antennas 720 and 730. The first and second feeders 740 and 750 may be spaced apart from each other. The first feeder 740 may be spaced apart from the first region 780. The second feeder 750 may be spaced apart from the first region 780.

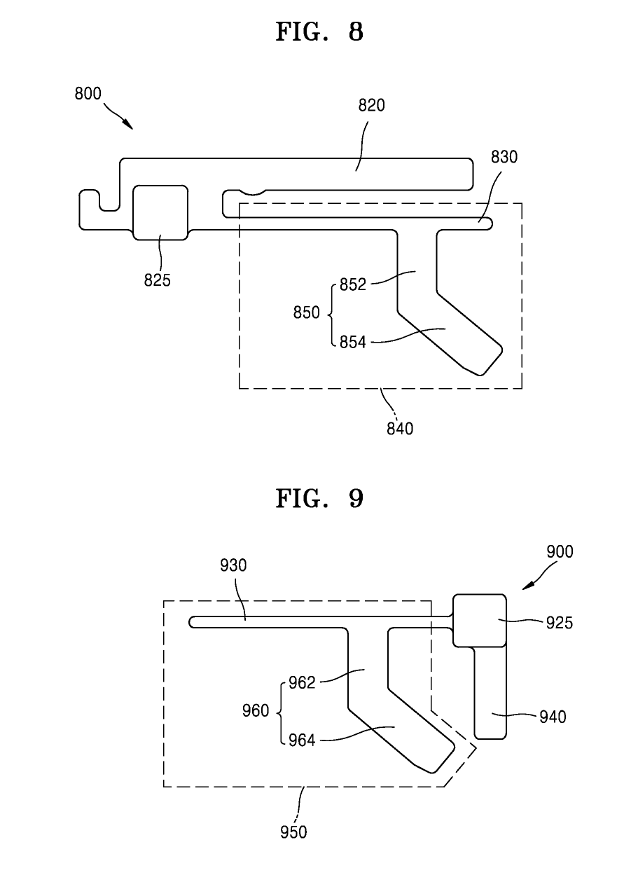

FIG. 8 is a plan view of an example of an antenna 800 disposed in an antenna device included in an electronic device according to various embodiments. For example, FIG. 8 is a plan view of the first antenna 720 of FIG. 7. For convenience, a substrate is not shown.

FIG. 8 is a plan view showing an example of the antenna 800 included in an electronic device according to various embodiments. The antenna 800 illustrated in FIG. 8 may correspond to the first antenna 720 of FIG. 7.

Referring to FIG. 8, the antenna 800 may include first and second horizontal portions 820 and 830. The first and second horizontal portions 820 and 830 may be parallel with and spaced apart from each other. Widths of the first and second horizontal portions 820 and 830 may be different from each other. For example, the width of the first horizontal portion 820 may be wider than the width of the second horizontal portion 830. Lengths of the first and second horizontal portions 820 and 830 may be equal to each other, but the second horizontal portion 830 may protrude to the right. One side of the first horizontal portion 820 and one side of the second horizontal portion 830 are connected to each other. A first feeder 825 may be positioned at a mutually connected part of the first and second horizontal portions 820 and 830. The first feeder 825 may be the first feeder 740 of FIG. 7. A part of the mutually connected part of the first and second horizontal portions 820 and 830 may protrude or expand. The first horizontal portion 820 may have an entirely uniform width, but may have a partially different width. For example, a part of one side of the first horizontal portion 820 may protrude convexly. At this time, the protruding part of the first horizontal portion 820 may be formed toward the second horizontal portion 830 but does not contact the second horizontal portion 830. The antenna 800 may include a first vertical portion 850 having a vertically extending part from the second horizontal portion 830. The first vertical portion 850 may extend in a direction away from the first horizontal portion 820. The first vertical portion 850 may include successive first and second expansion portions 852 and 854. The first expansion portion 852 may be a portion expanded from the second horizontal portion 830 and may be perpendicular to the second horizontal portion 830. A beginning part of the first expansion portion 852 may be located between the opposite ends of the second horizontal portion 830. The second horizontal portion 830 may be in an X-axis direction in an X-Y plane, and the first expansion portion 852 may be in a −Y axis direction. The second expansion portion 854 may expand from the first expansion portion 852 and may be regarded as continuously expanding from the first expansion portion 852. The second expansion portion 854 may expand in an inclined direction with respect to the second horizontal portion 830. The second expansion portion 854 may expand to a fourth quadrant in the X-Y plane. The second expansion portion 854 may be at an acute angle with the second horizontal portion 830. A first portion 840 including the second horizontal portion 830 and the first vertical portion 850 in the antenna 800 may be a portion that overlaps a neighboring antenna (e.g., the second antenna 730 of FIG. 7). The first portion 840 may overlap with a part of the neighboring antenna, but may not directly contact the neighboring antenna. The configuration of the antenna 800 may be divided into the first and second horizontal portions 820 and 830 and the first vertical portion 850 for the sake of convenience. However, the antenna 800 may be arranged as a single unit as a whole. Also, in FIG. 8, the overall shape of the antenna 800 may be modified, and the shapes and dimensions (length, width, thickness, etc.) of components constituting the antenna 800, mutual arrangement, and the like may be different from the illustrated example.

FIG. 9 is a plan view showing an example of an antenna 900 disposed in an antenna device included in an electronic device according to various embodiments.

The antenna 900 illustrated in FIG. 9 is, for example, a plan view of the second antenna 730 in FIG. 7. For convenience, a substrate is not shown.

Referring to FIG. 9, the antenna 900 may include a first horizontal portion 930 and a first vertical portion 940 being perpendicular thereto. One side of the first horizontal portions 930 and one side of the first vertical portions 940 may be connected. The width of the first vertical portion 940 in a direction perpendicular to a longitudinal direction may be greater than the width in a direction perpendicular to a longitudinal direction of the first horizontal portion 930. The length of the first vertical portion 940 may be shorter than the length of the first horizontal portion 930. The antenna 900 may include a second vertical portion 960. A beginning part of the second vertical portion 960 may be located between the opposite ends of the first horizontal portion 930. The second vertical portion 960 may include successive first and second expansion portions 962 and 964. The first expansion portion 962 may be a portion expanded from the first horizontal portion 930, may be perpendicular to the first horizontal portion 930, and may be parallel to the first vertical portion 940. The first horizontal portion 930 may be in an X-axis direction in an X-Y plane, and the first expansion portion 962 may be in a −Y axis direction. The second expansion portion 964 may expand from the first expansion portion 962 and may be regarded as continuously expanding from the first expansion portion 962. The second expansion portion 964 may expand in an inclined direction with respect to the first horizontal portion 930. The second expansion portion 964 may expand to a fourth quadrant in the X-Y plane. The second expansion portion 964 may be at an acute angle with the first horizontal portion 930. The shape, size and expansion direction of the second vertical portion 960 may be the same as those of the first vertical portion 850 of the antenna 800 of FIG. 8. A first portion 950 of the antenna 900 including the first horizontal portion 930 and the second vertical portion 960 may be a portion that overlaps with the first portion 840 of the antenna 800 of FIG. 8. The first portion 840 of FIG. 8 and the first portion 950 of FIG. 9 may not be in direct contact with each other.

In FIG. 9, the configuration of the antenna 900 of FIG. 9 may be divided into the first and second vertical portions 930 and 940 and the first horizontal portion 930 for the sake of convenience. However, the antenna 900 may be arranged as a single unit as a whole. Also, the overall shape of the antenna 900 may be modified, and the shape and dimensions (length, width, thickness, etc.) of components constituting the antenna 900, mutual arrangement, and the like may be different from the illustrated example.

The antenna device included in the electronic device according to various embodiments may include at least two conductive patterns (conductive layers) spaced apart from each other, and an insulating layer provided between the two conductive patterns spaced apart from each other, wherein the two conductive patterns may be vertically stacked and partially overlap each other.

According to various embodiments, the two conductive patterns (first and second conductive layers) may be MIMO antennas.

According to various embodiments, feeders may be connected to the two conductive layers, respectively.

According to various embodiments, an adhesion layer may be further provided between the insulating layer and the two conductive layers.

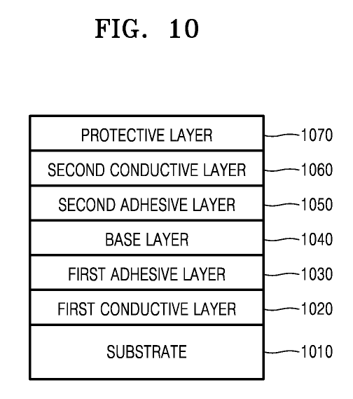

FIG. 10 is a cross-sectional view showing an arrangement of antennas mounted on an antenna device included in an electronic device according to various embodiments.

FIG. 10 is, for example, a cross-sectional view of FIG. 7 cut along a 7-7′ direction.

An example of a sectional configuration of the antenna mounted on the antenna device included in the electronic device according to various embodiments and an overlapping portion, and an example of a manufacturing process of the mounted antenna may be seen through FIG. 10.

Referring to FIG. 10, a first conductive layer 1020 may be positioned on a substrate 1010. The substrate 1010 may be at least one of a PCB and an FPCB. The first conductive layer 1020 may be a conductive pattern. The first conductive layer 1020 may be, for example, either the antenna 800 of FIG. 8 or the antenna 900 of FIG. 9. At least a part of the first conductive layer 1020 may include at least one of copper (Cu) and other conductive components. The thickness of the first conductive layer 1020 may be, for example, about 18 μm, but is not limited to this thickness. A first adhesive layer 1030, a base layer 1040, a second adhesive layer 1050 and a second conductive layer 1060 may be sequentially stacked on the first conductive layer 1020. The first adhesive layer 1030, the base layer 1040 and the second adhesive layer 1050 may be insulating layers. Accordingly, the first adhesive layer 1030, the base layer 1040, and the second adhesive layer 1050 may serve as an interlayer insulating layer between the first and second conductive layers 1020 and 1060. A part of the interlayer insulating layer may be embedded in the first conductive layer 1020. Also, another part of the interlayer insulating layer may be embedded in the second conductive layer 1060. The first adhesive layer 1030 may be formed to have a thickness of, for example, about 15 μm, but may not be limited to this thickness. The base layer 1040 may be a Pi base layer. The base layer 1040 may be formed to have a thickness of, for example, about 12.5 μm, but may not be limited to this thickness. The second adhesive layer 1050 may be formed to have a thickness of, for example, about 15 μm, but may not be limited to this thickness. The second conductive layer 1060 may be a conductive pattern. The second conductive layer 1060 may be, for example, either the antenna 800 of FIG. 8 or the antenna 900 of FIG. 9. For example, when the first conductive layer 1020 is the antenna 900 of FIG. 9, the second conductive layer 1060 may be the antenna 800 of FIG. 8, or vice versa. At least a part of the second conductive layer 1060 may include at least one of copper (Cu) and other conductive components. The thickness of the second conductive layer 1060 may be, for example, about 18 μm, but is not limited thereto. The second conductive layer 1060 may be formed such that a part of the second conductive layer 1060 overlaps with a part of the first conductive layer 1020 in a process of forming the second conductive layer 1060. A protective layer 1070 may be formed on the second conductive layer 1060. The protective layer 1070 may be a protective tape.

According to various embodiments, a first conductive layer, an insulating layer, and a second conductive layer may be sequentially stacked on the substrate in the antenna of the antenna device included in the electronic device, and the first conductive layer and the second conductive layer may be formed for vertical coupling.

According to various embodiments, the substrate may be at least one of a PCB and an FPCB.

According to various embodiments, the first conductive layer and the second conductive layer may be formed such that the first conductive layer and the second conductive layer partially overlap each other. When forming the second conductive layer, a part of the second conductive layer may be disposed on a partial region of the first layer.

According to various embodiments, an adhesion layer may be further formed between the insulating layer and the first and second conductive layers.

According to various embodiments, a feeder connected to the first conductive layer and a feeder connected to the second conductive layer may be further formed.

As described with reference to FIGS. 8-10, the first antenna 720 (e.g., the second conductive layer 1060) and the second antenna 730 (e.g., the first conductive layer 1020) in the antenna device may be vertically spaced and are not in direct contact. However, the first conductive layer 1020 and the second conductive layer 1060 may have an overlapping part, and thus electrical coupling (electromagnetic coupling) may be formed. Accordingly, the frequency radiation characteristic with the isolation characteristic equivalent to that of the direct connection between a feeder of the first antenna 720 and a feeder of the second antenna 730 may be improved, thereby preventing the antenna efficiency from being lowered in a specific band (e.g. 5 GHz band).

Also, since the first antenna 720 and the second antenna 730 have a non-contact vertical coupling structure, when the antenna device connects a metal feeder and a non-metal feeder to each other, an additional element for preventing electric shock may not be required. Therefore, a relatively large mounting space compared with the existing one may be secured.

Meanwhile, when an overlapping area of the first antenna 720 and the second antenna 730 is A, a gain of the first antenna 720 is G3, a gain of the second antenna 730 is G4, and a distance (corresponding to a distance between the first and second conductive layers 1020 and 1060 of FIG. 10) between the overlapping portions (840 of FIG. 8 and 950 of FIG. 9) of the first and second antennas 720 and 730 is d, the isolation between the first antenna 720 and the second antenna 730 may be proportional to A and inversely proportional to the gain and the distance.

Table 1 below shows an envelope correlation coefficient (ECC) when an electronic device including an antenna according to various embodiments, for example, an antenna with vertical coupling, is applied. Table 2 shows an ECC when a thin antenna with vertical coupling is not applied, that is, a general antenna is applied. Frequencies F1-F7 used to obtain the results of Table 1 and frequencies used to obtain the results of Table 2 may be the same.

TABLE 1

| Frequency | ECC |
|---|---|
| F1 | 0.3329 |
| F2 | 0.3164 |
| F3 | 0.2283 |
| F4 | 0.2354 |
| F5 | 0.1818 |
| F6 | 0.1590 |
| F7 | 0.1951 |

TABLE 2

| Frequency | ECC |
|---|---|
| F1 | 0.4565 |
| F2 | 0.4862 |
| F3 | 0.4513 |
| F4 | 0.3972 |
| F5 | 0.3331 |
| F6 | 0.3852 |
| F7 | 0.3431 |

Referring to Tables 1 and 2, it may be seen that the ECC (Table 1) when the antenna having the vertical coupling structure is used is smaller than the ECC (Table 2) when the general antenna is used.

For example, when the antenna having the vertical coupling structure is used, the ECC at the first frequency F1 to the seventh frequency F7 are 0.1590 at the minimum and 0.3329 at the maximum, whereas when the general antenna is used, the ECC at the first frequency F1 to the seventh frequency F7 are 0.3331 at the minimum and 0.4862 at the maximum. That is, the maximum ECC (0.3329) when the antenna having the vertical coupling structure is used is smaller than the minimum ECC (0.3331) when the general antenna is used.

These results suggest that the antenna isolation characteristics are better when the antenna having the vertical coupling structure is used than those when the antenna having the vertical coupling structure is not used.

The present disclosure may be used in electronic devices that use antennas for communication. For example, it may be used in a mobile phone, and may be applied to a portable or fixed communication device.

Although many matters have been described in detail above, they should not be construed as limiting the scope of the disclosure, but rather should be interpreted as examples of preferred embodiments. Therefore, the scope of the present disclosure is not to be determined by the described embodiments but should be determined by the technical idea described in the claims.

What is claimed:

1. An antenna device comprising:
a first conductive pattern;
a second conductive pattern spaced apart from the first conductive pattern; and
an insulating layer between the first conductive pattern and the second conductive pattern,
wherein the first conductive pattern and the second conductive pattern at least partially overlap each other when viewed from above.

2. The antenna device of claim 1, wherein the first and second conductive patterns are MIMO antennas or Wi-Fi antennas.

3. The antenna device of claim 1, wherein an adhesive layer is disposed between the insulating layer and the first and second conductive patterns.

4. An electronic device comprising:
a housing comprising a first surface facing a first direction, a second surface facing a second direction that is a direction opposite to the first direction, and a side member surrounding a space between the first surface and the second surface;
a first conductive pattern inside the housing;
a second conductive pattern inside the housing, the second conductive pattern being spaced apart from the first conductive pattern and extending substantially parallel to the first conductive pattern, wherein at least a part of the second conductive pattern overlaps the first conductive pattern when viewed from above the first conductive pattern;
an insulating material between the first conductive pattern and the second conductive pattern; and
at least one wireless communication circuit electrically connected to the first conductive pattern at a first point and electrically connected to the second conductive pattern at a second point spaced apart from the first point.

5. The electronic device of claim 4, wherein the first conductive pattern extends parallel to the second surface.

6. The electronic device of claim 4, wherein the at least one wireless communication circuit is configured to provide at least one Wi-Fi signal to each of the first and second points.

7. The electronic device of claim 6, wherein the at least one wireless communication circuit is further configured to provide a MIMO signal by using the first and second conductive patterns.

8. The electronic device of claim 4, further comprising:
a first insulating layer attached to or embedded in the first conductive pattern; and
a second insulating layer attached to or embedded in the second conductive pattern,
wherein the second insulating layer is coupled to the first insulating layer.

9. The electronic device of claim 4, wherein the at least one wireless communication circuit is configured to transmit and receive a signal related to at least one of RF, GPS, NFC, and Bluetooth by using the side member.

10. The electronic device of claim 4, wherein the at least one wireless communication circuit is configured to transmit and/or receive a signal within a frequency range of about 600 MHz to about 5.9 GHz.

11. An electronic device comprising:
a plurality of antennas;
a feeder; and
a communication module coupled to the feeder,
wherein two adjacent antennas selected from among the plurality of antennas comprise:
a first conductive pattern;
a second conductive pattern spaced apart from the first conductive pattern; and
an insulating layer between the first conductive pattern and the second conductive pattern,
wherein the first conductive pattern and the second conductive pattern at least partially overlap each other when viewed from above, and
wherein the communication module is electrically connected to the first conductive pattern at a first point and electrically connected to the second conductive pattern at a second point spaced apart from the first point.

12. The electronic device of claim 11, further comprising: a metal bezel surrounding the feeder and the communication module.

13. The electronic device of claim 11, wherein the plurality of antennas at least comprise an RF antenna and a GPS antenna.

14. The electronic device of claim 11, wherein the selected two adjacent antennas are Wi-Fi antennas.

15. The electronic device of claim 12, wherein the metal bezel comprises a segmentation unit.
